(19) United States
(12) Patent Application Publication
(10) Pub. No.: US 2013/0181436 A1
(43) Pub. Date: Jul. 18, 2013

(54) Sealing and Filling Flange Ring for Injection Joints

(71) Applicant: IPS Corporation, Compton, CA (US)

(72) Inventors: Terry R. McPherson, Mebane, NC (US); Jack Roach, Durham, NC (US); Fabio Castellani, Streamwood, IL (US)

(73) Assignee: IPS CORPORATION, Compton, CA (US)

(21) Appl. No.: 13/738,323

(22) Filed: Jan. 10, 2013

Related U.S. Application Data
(60) Provisional application No. 61/585,733, filed on Jan. 12, 2012.
(60) Provisional application No. 61/621,794, filed on Apr. 9, 2012.

(51) Int. Cl. F16L 13/10

(52) U.S. Cl. CPC F16L 13/103
USPC 285/22; 156/293

(57) ABSTRACT

An injection joint for a socket and pipe end pipe joint, which includes a socket, a pipe end inserted into the socket with a gap therebetween, and an flange ring capping the socket. Flange rings are disclosed which include an injection port and/or a slit. Injection joints may provide a recess in the pipe OD into which the flange ring is received, the recess functioning to stop travel of the flange ring during injection and widening the gap to facilitate adhesive travel. The split in the ring facilitates mounting the ring into the recess and functions as exit port.

### CROSS REFERENCE TO RELATED APPLICATIONS

This application claims the benefit of U.S. Provisional Application No. 61/585,733, filed on Jan. 12, 2012 and U.S. Provisional Application No. 61/621,794 filed Apr. 9, 2012, the entire contents of which are incorporated herein by reference.

### BACKGROUND OF THE INVENTION

The present invention relates to novel constructions for injection pipe joints.

Injection joints for coupling pipes are known for instance from U.S. Pat. No. 3,920,787, U.S. Pat. No. 3,920,268, U.S. Pat. No. 4,523,779, U.S. Pat. No. 5,486,024, U.S. Pat. No. 7,341,285, and published applications US 2006/0191623, US 2010/0259040 and JP 05-346189. In injection pipe joints an adhesive is injected via a hole in the socket into a gap between a socket and an inserted pipe end and allowed to set after the socket and pipe end have been initially fitted together.

In some of the injection joint designs the mouth of the socket is capped by an annular flange ring fitting that closes the gap between the socket and the pipe end. Such flange ring fittings also serve to center the axis of the socket and pipe inserted into the socket. However, they are not reliably retained in position during adhesive injection unless they are clamped during injection and sometimes until the adhesive has fully cured.

The injection joint systems have the advantage that substantially 100% solids adhesive can be used putting the joint under less shrinkage stress than solvent adhesives, there is lower worker and environmental emission, and in many cases a wider range of pipe materials can be successfully mated. However, a difficulty in establishing an injection joint system is that most pipe end and socket joints are designed for use with solvent cement systems which have gaps that are too narrow to provide effective injection of most adhesives. It is difficult to supplant an existing system if pipe specifications have to be rewritten and/or sockets redesigned, or if there are significant increases in labor time to modify current commercial pipes and/or sockets to implement an injection joint.

It would be desirable to provide an injection joint system that can use existing pipe specifications and yet provides the desired gap properties. It would also be desirable to simplify the process to reduce the time needed to form an injection joint from existing pipe and fittings so that it effectively can compete with existing pipe joint systems.

### SUMMARY OF THE INVENTION

The invention pertains to an injection joint that is more easily adapted to implementation with existing pipe and socket joint designs.

In some aspects the invention pertains to improved flange ring for an injection joint which includes an injection port. The injection port communicates with a channel which opens to the socket/pipe gap when assembled. The channel distributes adhesive to a gap between the pipe end and socket. The channel may be formed as a recess or slot in the inner wall of the ring.

Further aspects pertain to a flange ring for an injection joint that is slit longitudinally to split the ring. In some embodiments the flange ring includes both an injection port and a longitudinal slit spaced circumferentially apart from the injection port in the circumferential direction. The slit provides an exit port for the adhesive. The slit also facilitates mounting of the ring on the pipe in some embodiments in which the flange ring is sized to fit into a recess in the outer wall of the pipe end.

Further aspects pertain to a method of forming an injection pipe joint comprising providing a pipe end with a bottom and a circumferential recess spaced upwardly from the bottom, fitting a flange ring having an inner wall, outer wall and an axially directed slit between the inner and outer walls, onto the pipe end to form a pipe end/flange ring assembly, at least a portion of inner wall sized to be received in the recess and limit upward motion of the flange ring in the assembled pipe joint, inserting pipe end/flange ring assembly into a socket to form an assembled pipe joint, the assembled pipe joint further comprising a gap between the pipe end and socket over a portion of the assembly inserted into the socket and an injection port, and injecting a curable adhesive to fill the gap and exit through the slit in the flange ring.

The method may also include the step of fitting the flange ring onto the pipe end, the flange ring is pulled open at the slit to slide the portion thereof that is received into the recess over the bottom of the pipe end into the recess in the outer wall of the pipe end.

Further aspects and embodiments are described in the Drawings, Detailed Description and/or Claims that follow.

### BRIEF DESCRIPTION OF THE DRAWINGS

FIG. 1 is a side plan view of an assembly of a first pipe end with a flange ring of one inventive embodiment mounted thereon and of a socket before insertion of the first pipe end/flange ring assembly therein.

FIG. 2 is a top perspective view of the flange ring shown in FIG. 1.

FIG. 3 is a bottom perspective view of the flange ring shown in FIG. 1.

FIG. 4 is a cross-sectional view of the pipe, flange ring and socket of FIG. 1 with the pipe and flange ring partially inserted into the socket.

FIG. 5 is a cross-sectional view of the assembled pipe joint assembly of FIG. 1.

FIG. 6 is a side plan view of an assembly of a first pipe end with an alternate embodiment of an inventive flange ring mounted thereon, and of a socket before insertion of the first pipe end/flange ring assembly therein.

FIG. 7 is a top perspective view of the flange ring shown in FIG. 6.

FIG. 8 is a bottom perspective view of the flange ring shown in FIG. 6.

FIG. 9 is a cross-sectional view of the assembled pipe joint assembly of FIG. 6.

FIG. 10 is a side plan view of an assembled joint of in FIG. 9, but with the socket formed of transparent plastic and showing the adhesive partially filling the gap.

FIG. 11 is a view as in FIG. 10 at the completion of adhesive injection.

### DETAILED DESCRIPTION OF THE INVENTION

All published documents, including all US patent documents, mentioned anywhere in this application are hereby expressly incorporated herein by reference in their entirety. Any copending patent applications, mentioned anywhere in this application are also hereby expressly incorporated herein by reference in their entirety.

The terms socket and pipe end are used herein to apply to pipe fitting joints in which a tubular end is fitted telescoping into a tube of larger diameter. The tubular portions may be formed integrally at the ends of pipes or be separate pipe fittings or a combination of a pipe fitting and a pipe end. The socket is the portion of the outer tube that is used in the assembled joint and the pipe end is the portion of the inner tube that is used in the joint. The joints may be linear, bent or branched, for instance a pipe having an enlarged end that joins to a straight pipe end, a sleeve fitting coupling two pipe ends, two pipes of different diameters fitted telescopingly, pipe fittings to heating tanks or boilers, and various multi-pipe fittings such as tee, Y and 4-way fittings coupling three or more pipe ends, manifold joints and the like.

As used herein the terms “top” and “bottom” and “up” and “down” are used arbitrarily to describe opposite axial directions in the pipe joint, and parts are named in relationship to that arbitrary choice. It will be understood that in practice the joint may be oriented in any direction. These descriptions do not imply the actual orientation of the joint relative to any external coordinates, in particular they are not relative to ground.

In accordance with some embodiments of the invention injection joints are simplified with a flange ring that is redesigned to include the injection port. The insertion portion of the flange ring is modified to include an inner channel that communicates with the injection port and directs the adhesive into the socket/pipe gap. Similarly, the flange ring can be configured to provide an outlet port for expelling air from the gap when adhesive is injected into the joint. These features minimize or eliminate the modifications needed to adapt a socket for use in an injection joint.

Use of a slit flange ring also allows the flange ring to be fitted on the pipe end by opening the ring so that the annular engagement of the ring occurs on a portion of the pipe end that has a recess in the outer surface. A suitably sized recess on the pipe end, in turn, provides an enhanced injection gap while maintaining desired alignment over the length of the joint. The pipe end recess also includes an edge which provides an axial engagement to the top of the flange ring, eliminating a need for clamping the flange ring during injection.

Various of these features can be implemented separately, in combination and/or in sub-combination. In a particularly preferred embodiment they are all implemented in a single embodiment as illustrated in the Figures.

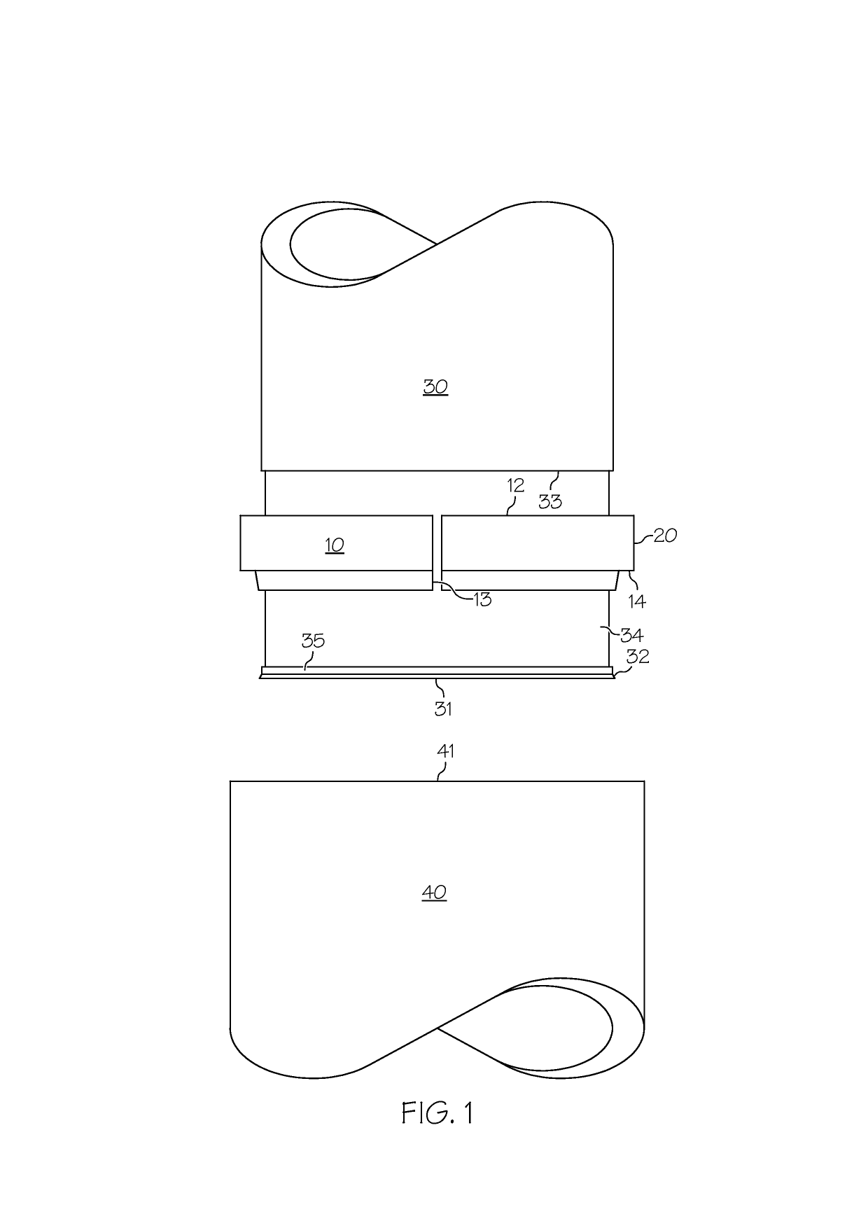

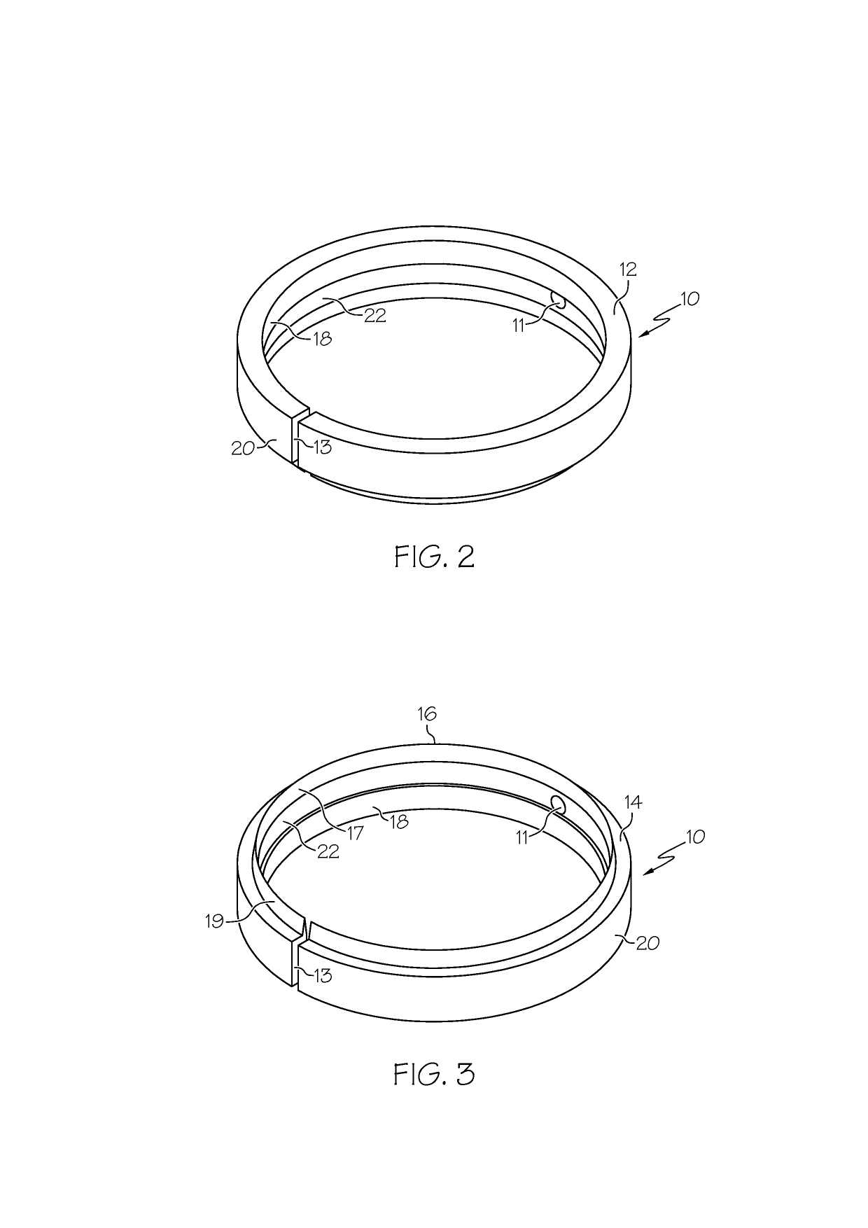

One embodiment of a flange ring of the invention is depicted in FIGS. 1-5. The flange ring 10 includes an injection port 11. A slit 13 is provided at a location spaced circumferentially from the injection port. In this embodiment the injection port is located diametrically opposite the injection port 11, as shown in FIGS. 2 and 3. The ring has a top side 12, a flange flat surface 14, a socket insertion portion 16, an inner ring wall 18 which provides and engagement surface with the pipe end, and an outer ring wall 20 that extends between the flange flat surface 14 and the top of the ring. A channel communicating with port 11 is provided by a recess 22 in the inner ring wall 18. In this embodiment the recess 22 is annular.

The slit 13 has two functions. It allows the flange ring to be opened sufficiently to be slipped over the bottom 31 of the pipe end during assembly, and it functions as the exit port for the adhesive. In this embodiment the insertion portion 16 is tapered on both the inner side 17 and outer side 19, so that the insertion portion becomes increasingly flexible moving down from the flange flat surface 14.

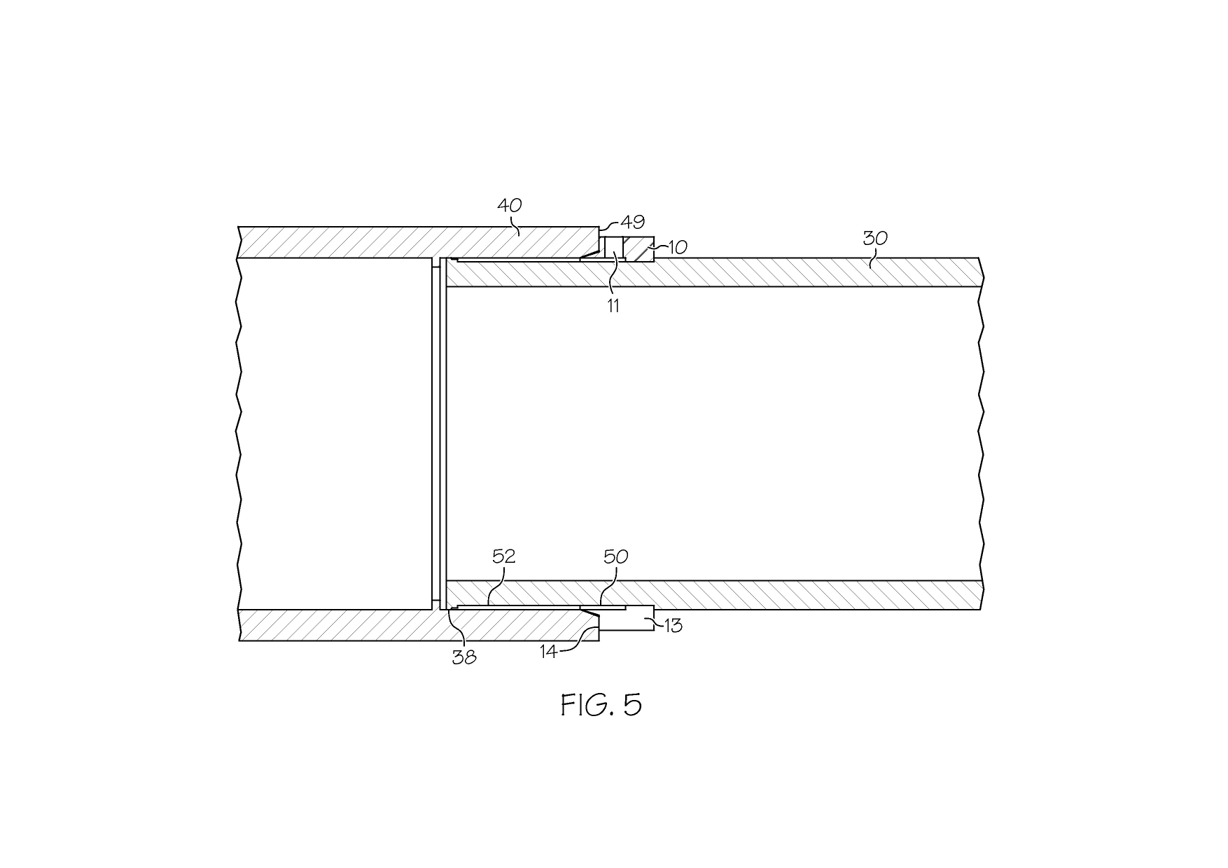

In assembly of the joint a first pipe 30 and a socket 50 are provided. Preferably an industrial standard plastic socket fitting and an industrial standard pipe are used. The pipe is cut with a square end. The first pipe has a diameter that is slightly smaller than the inner diameter of the socket so that the two can be fitted with a gap. The pipe end 31 is square cut (i.e. perpendicular to its axis), suitably with a wheel cutter that leaves a small raised edge 32. The raised edge can be left in place and force fit into the socket to provide a very short region of interference between the pipe end and the socket as shown at 38 in FIG. 5. The pipe fitter can force fit the raised edge into the socket, typically without mechanical assistance, although for some fittings it may be useful to utilize a tool that axially forces the pipe into the socket (or vice versa). The interference fit at 38 provides sufficient sealing of the bottom of the gap to allow injection of the adhesive without significant leakage at the socket bottom.

A short distance from the pipe end 31, a recess 34 in the outer wall is provided. A stub 35 is left at the end that retains the original pipe diameter. The recess 34 may be provided by routing or grinding at the site of installation. The length of stub 35 is not particularly critical, so long as a sufficient length of original pipe diameter is provided to assure axial alignment of the pipe in the socket and to support the interference fit of the edge 32. This will depend on the diameter of the pipes being joined and the length of the socket, but typically may be in the range of about 0.2-1 inches (5-25 mm), for instance about 0.25″-0.5.″ (6-13 mm), or 0.25-0.375 inches (6-10 mm), for pipes having diameters in the range of 1-12 inches (25-305 mm). In some embodiments the stub length is in the range of 5-33% of the length of the pipe end that is inserted into the socket. In some embodiments a router is may be mounted a wheeled cutter so that the pipe is cut and the recess 34 is routed in the same operation. This has the advantage that the spacing of the recess is fixed reliably with each pipe cut. The recess 34 provides an enlargement of the manufactured gap between the socket and pipe so that the adhesive flow during injection can be controlled at relatively low injection pressure, e.g., the pressure provided with mechanical caulking guns and similar devices.

The depth of the recess 34 is not particularly critical, but should not be sufficient to materially reduce the burst rating of the first pipe and still provide some increase in adhesive flow rate. Depths of 0.01-0.05 inches (0.25-1.25 mm) for instance 0.015-0.03 inches (0.38-0.76 mm) may be suitable. In an alternative, not shown, the diameter of the first pipe may interfere with the socket and the length of stub 35 may be sized to allow it to be force fit into the socket. In such case the recess 34 might need to be somewhat deeper.

The diameter of the inner ring wall 18 of the flange ring is substantially the same as that of the outer diameter of the first pipe in the recess 34. This provides frictional engagement of the flange ring with the pipe end in the recess 34.

To assemble a pipe joint the flange ring is pulled open at the slit 13 sufficiently to be fitted over the pipe end and into the recess 34 as shown in FIG. 1. The flange ring is then slid up the recess until the top 12 contacts the upper recess edge 33 of the first pipe. The upper recess edge 33 functions as a stop, preventing further upper displacement of the flange ring as the first pipe end is inserted into the socket and when the adhesive is injected.

The socket 40, may be a bell on the end of a second pipe or may be any pipe fitting with a cavity sized to closely receive a pipe of the diameter of the first pipe. The socket has a top end 42, and a substantially cylindrical inner wall 44 which has an inner diameter. In some embodiments a bevel 48 between the socket end and the inner wall 44 is provided to facilitate insertion and alignment of the axes of the first pipe and the socket.

In some embodiments the socket includes an inner bottom 49 of reduced diameter which limits the distance in which a pipe end may be inserted, but this is not a necessary feature of a socket and pipe end joint or of the inventive joints. In the embodiment shown in FIGS. 1-5, the location of edge 33 of the pipe end and the length of the outer wall 20 of the flange ring will set the limit that the pipe end may be inserted and the upper edge 33 should be set at a location which allows insertion of the pipe end only for a distance that is less than or equal to the distance from the top 41 of the socket to the bottom 49.

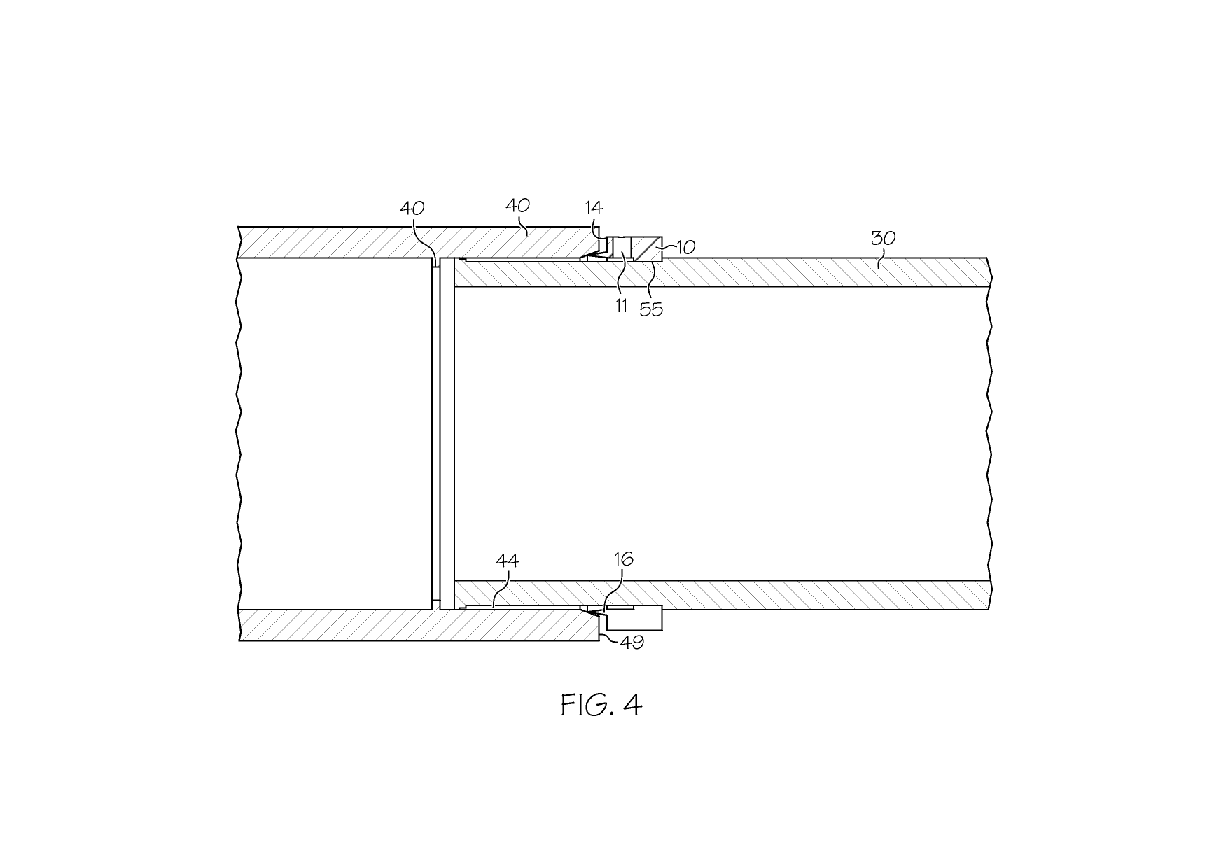

Referring to FIG. 4, the insertion portion of flange ring is sized so that the bottom of the insertion portion 16 contacts the bevel 48 as the first pipe is inserted into the socket. The thin flexible end of the insertion portion will be deflected inward by the bevel 48 as the first pipe inserted further into the socket.

Referring to FIG. 5, a fully assembled joint is shown before adhesive injection. The flange flat surface 14 contacts the top 49 of the socket, the top of the flange ring contacts the upper edge of the recess, the insertion portion of the flange ring has been deflected inward, but the tapering of the inner wall results in a channel 50 that is largely the same size as the gap 52 between the socket and pipe recess.

Injection of adhesive through port 11 will fill gap 44 circumferentially. The viscosity of the adhesive is suitably low enough to assure that there are no voids formed. As the adhesive is injected, pressure against the thin insertion portion of the ring maintains a seal along the bevel 48, frictional engagement between the inner wall 18 of the ring and the recess 34 maintains a seal at the interface 55, and the interference fit at the bottom of the pipe end seals the bottom of the gap. Air being expelled through the slit 13 prevents the adhesive from filling the slit until the adhesive has filled the gap. The slit is monitored and the adhesive injection is stopped went the adhesive appears at the slit, or just slightly exudes from the gap.

The engagement of the top side 12 of the flange ring with the edge 33 of the pipe recess 34 blocks axial displacement of the flange ring when the assembled joint is injected with adhesive. In embodiments of the invention employing this feature it is not necessary to hold or clamp the ring during injection.

The difference between the inner diameter of the socket and the outer diameter of the pipe may correspond to the manufacturing specifications for conventional solvent adhesive joints. The difference defines a narrow gap which is inherent in the assembly. The depth of the recess 34 is sufficient to provide an enlarged gap 52 that is large enough to facilitate the desired circumferential flow of the adhesive to be injected.

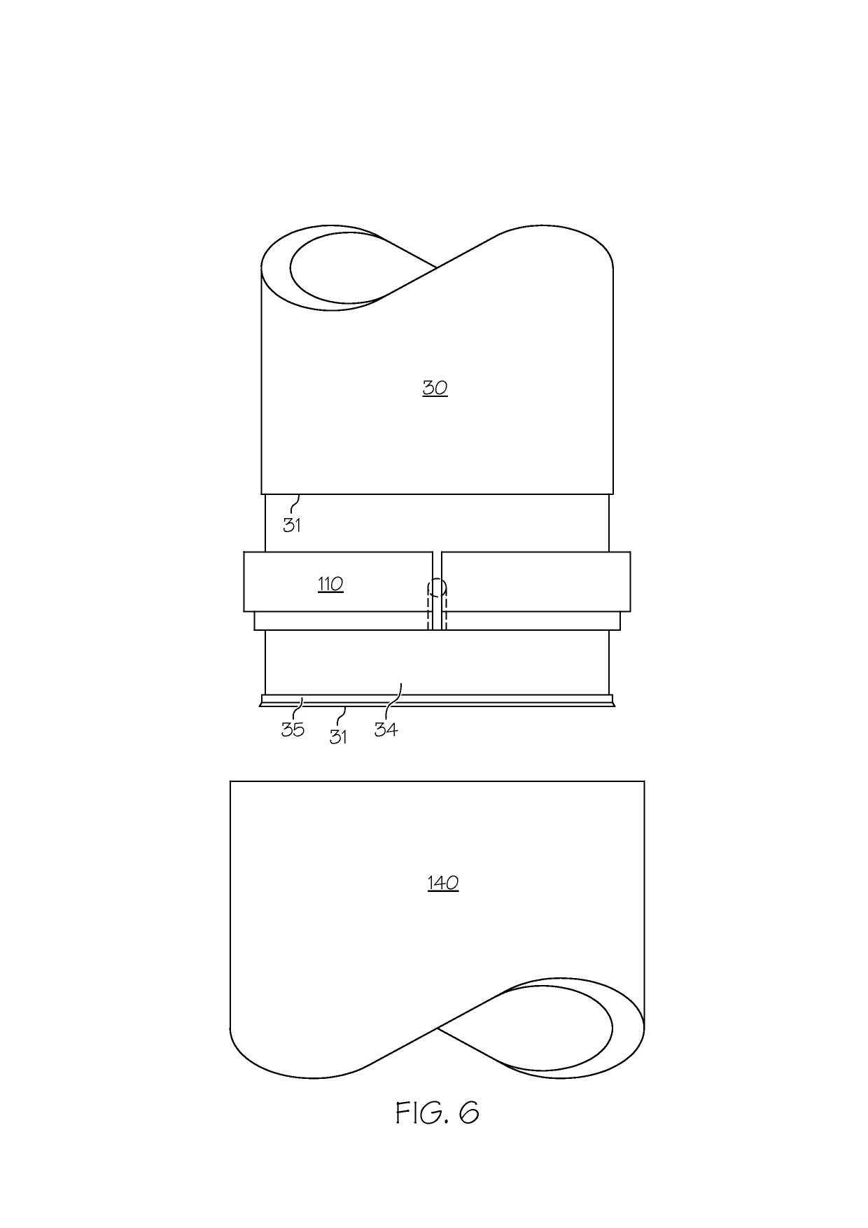

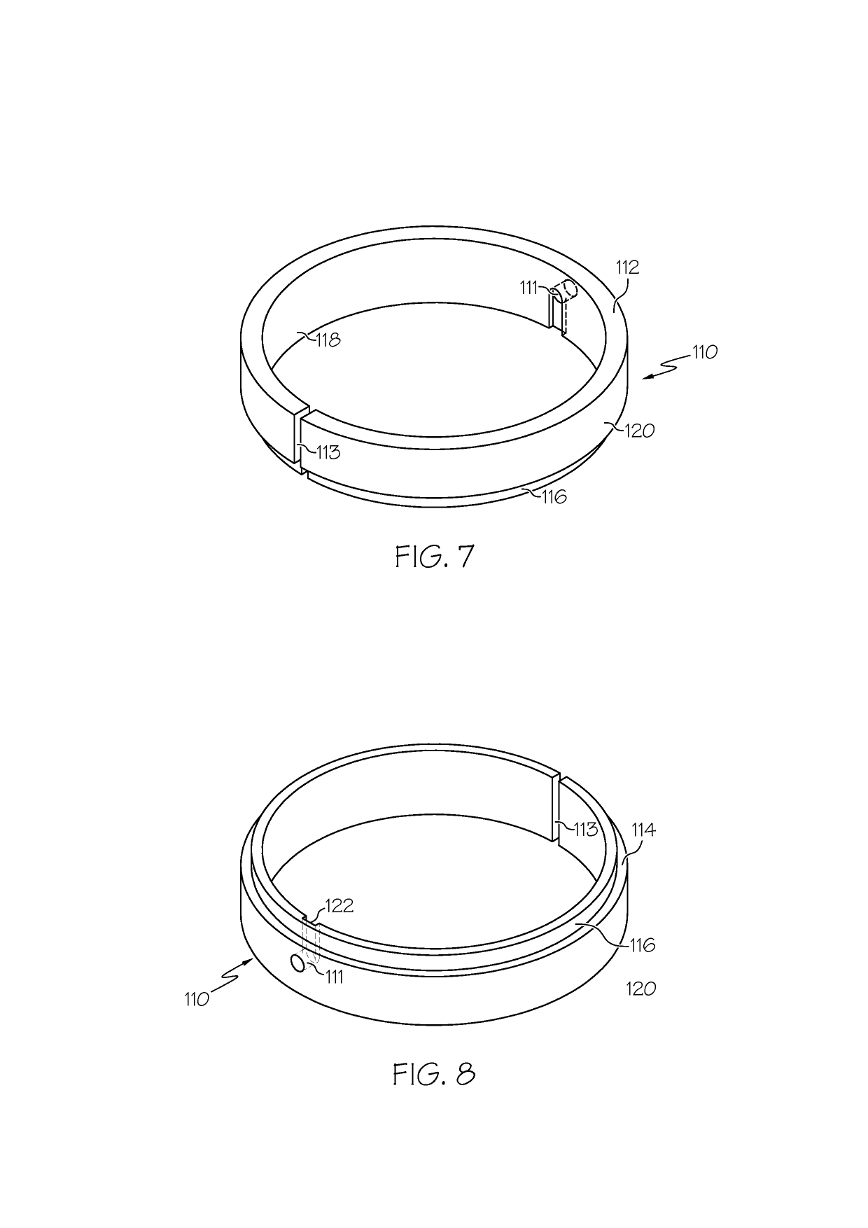

Another embodiment of an inventive flange ring is shown in FIGS. 6-11. The flange ring 110 includes an injection port 111. A slit 113 is provided at a location spaced circumferentially from the injection port, suitably diametrically opposite the injection port as shown in FIGS. 7 and 8. The ring has a top side 112, a flange flat surface 114, a socket insertion portion 116, and an inner engagement surface which is the inner ring wall 118 and an outer ring wall 120 that extends between the flat surface 114 and top of the ring. A channel communicating with port 111 is provided by a slot 122 in the inner ring wall. The channel communicates with the gap into which the adhesive will be injected. In this embodiment the slit 113 also has two functions. It allows the flange ring to be opened sufficiently to be slipped over the end portion 31 of the pipe end during assembly, and it functions as the exit port for the adhesive. In this embodiment the insertion portion 116 is straight on both the inner and outer sides.

The first pipe end is prepared in the same way as the previous embodiment and the same numerals are shown for the features of thereof. The inner wall of the flange ring is substantially the same as the outer diameter of the pipe end in recess 34 so that it frictionally engages the recess when mounted thereon.

The socket 140 has a top end 142, and a substantially cylindrical inner wall 144 which has an inner diameter. In this embodiment the socket wall has a reduced wall thickness at end portion 145 at the top end of the socket. The reduced wall thickness is provided by a enlargement of the inner diameter of the socket. This may be a feature of the socket as manufactured or it may be a modification made at the time of installation, e.g. by routing or grinding an annular ring in the inner wall of a manufactured socket. The thinner wall at end portion 145 provides room to accommodate the insertion portion of the flange ring 110, and may also provide a somewhat greater wall flexibility relative to the remaining portion of the socket wall.

The thickness of the insertion portion 116 of the flange ring 110 is preferably set to provide a very slight interference with the socket at end portion 145, but preferably not more than can be accommodated by hand forcing of portion 116 into the socket end portion 145. For instance in socket for a 10″ diameter polyolefin pipe an interference of 0.001-0.005 inches may be suitable.

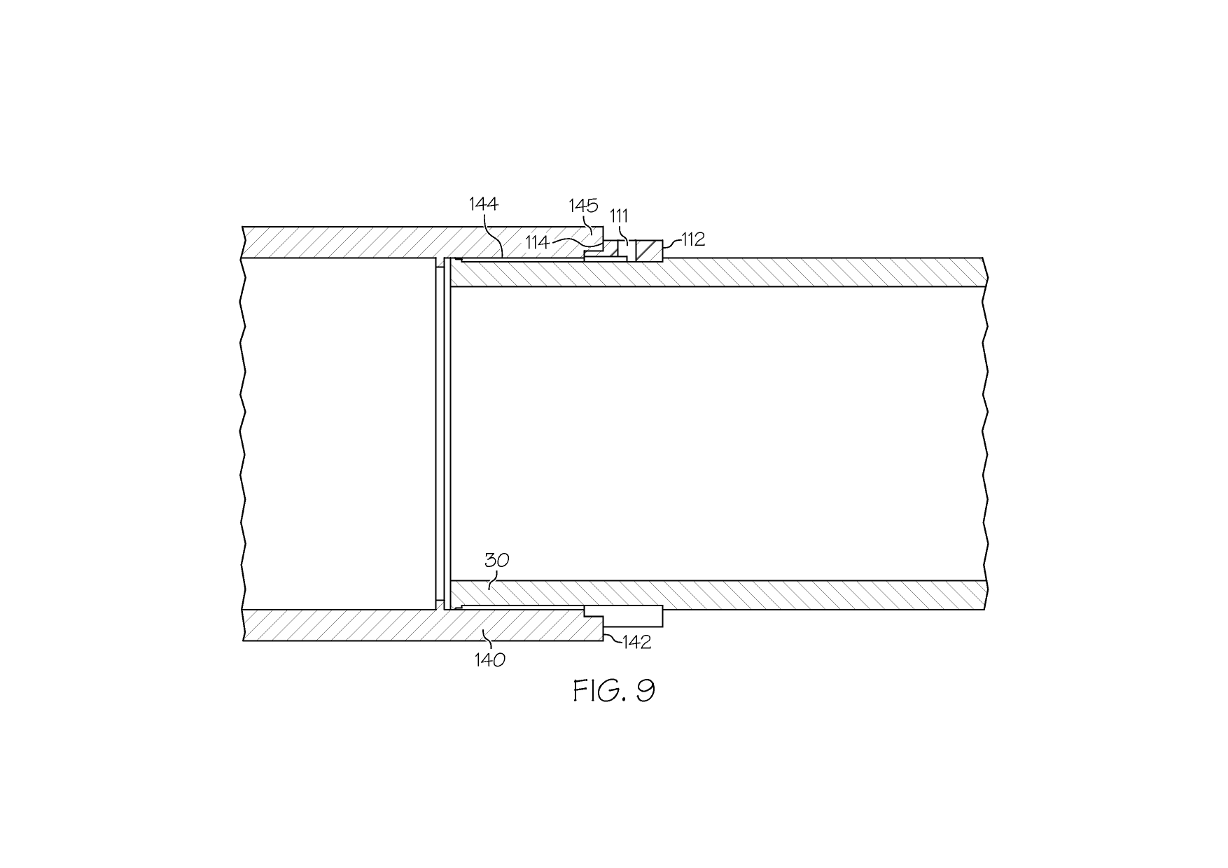

Referring to FIG. 9, a fully assembled joint of the second embodiment is shown before adhesive injection. The flange flat surface 114 contacts the top 149 of the socket, the top of the flange ring contacts the upper edge of the recess, the insertion portion of the flange ring is sealed on both inner and outer sides due to the radial pressure provided by the slight interference with socket end portion 145.

The engagement of the top side 112 of the flange ring with the edge 33 of the pipe recess 34 blocks axial displacement of the flange ring when the assembled joint is injected with adhesive.

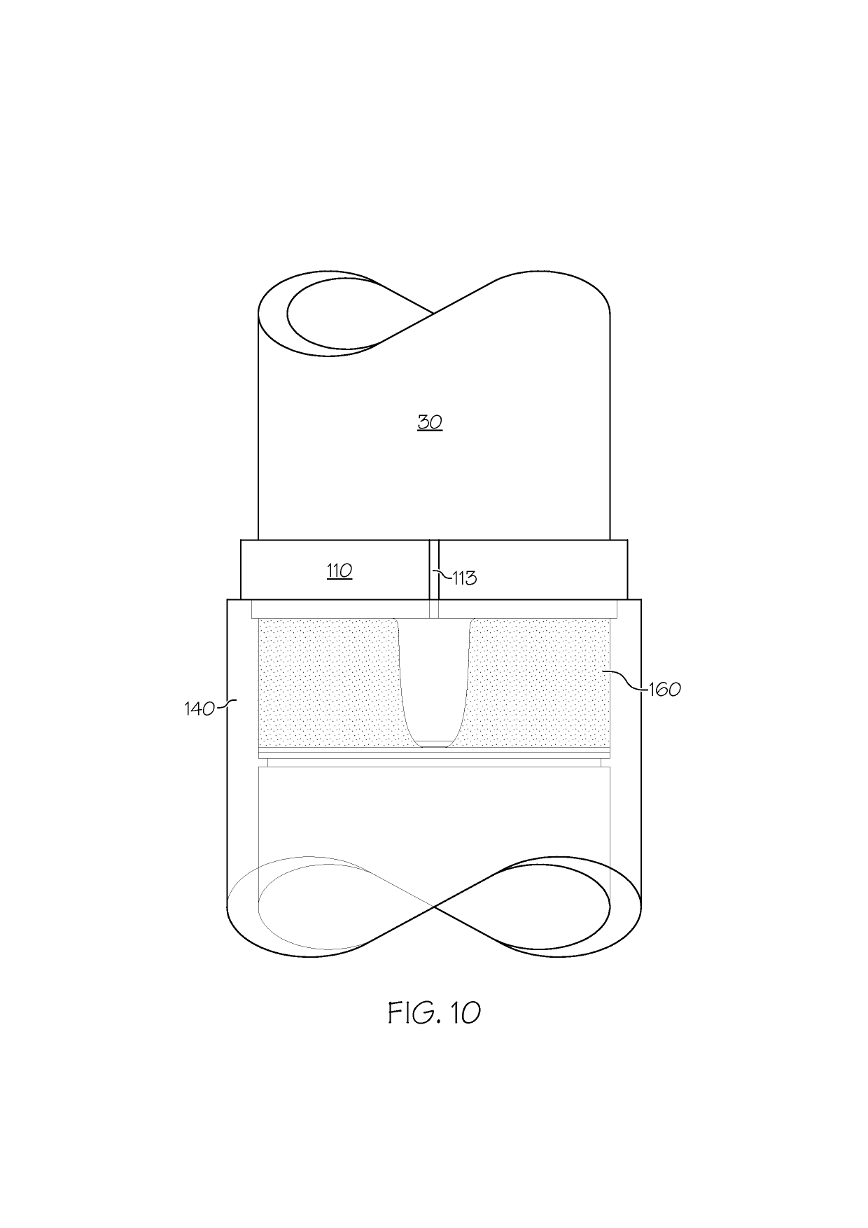

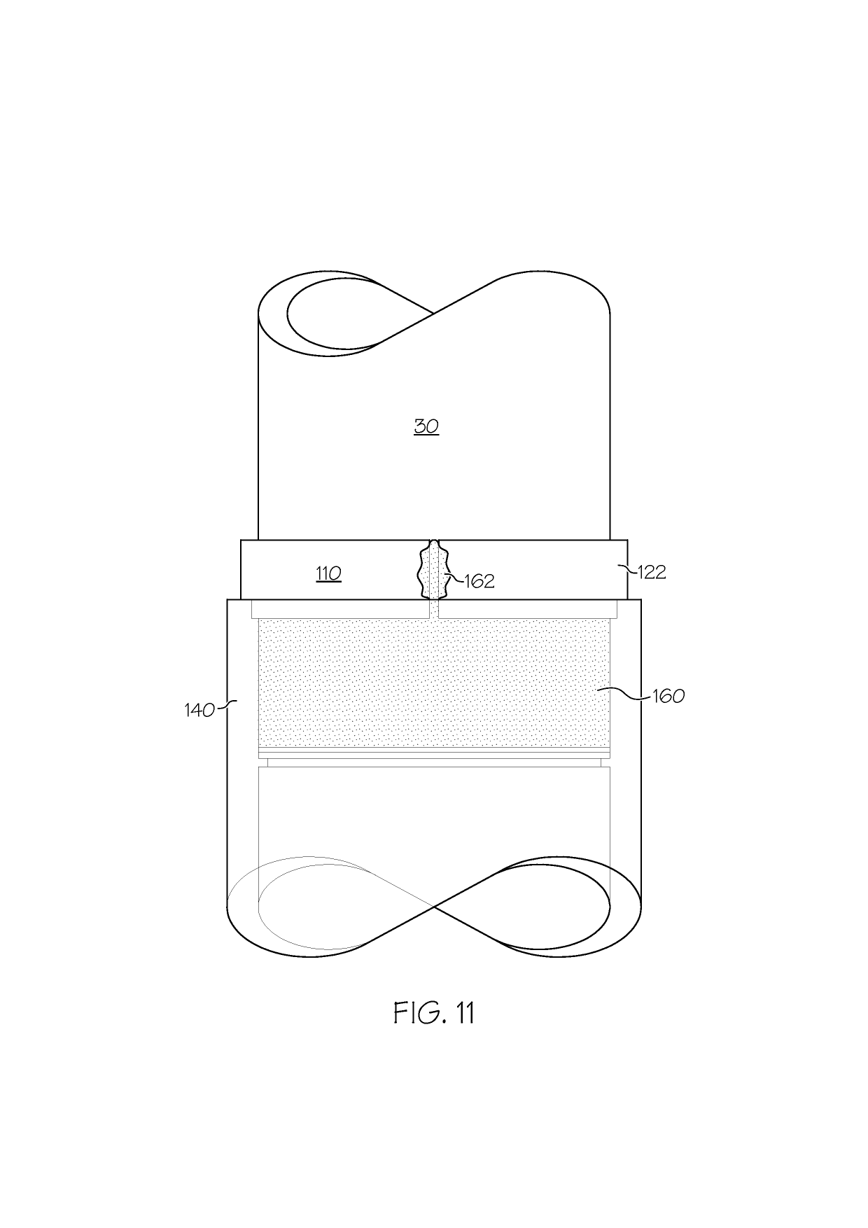

FIG. 10 is a side view of a joint as in FIG. 8 in which the socket 140 has been formed of transparent plastic. Adhesive material 160 is being injected. The gap is filled circumferentially first at the bottom of the joint because air being expelled though the slit keeps the gap open at the top.

FIG. 11 is a view as in FIG. 9, with the adhesive just emerging from the slit. The pipe fitter can watch for the appearance of the adhesive and stop injection pressure at this point. In at least some embodiments a button 162 of adhesive is allowed to slightly overlap the outer wall 122 of the flange ring so that the edge of the slit 113 are held mechanically, as well as adhesively, when the adhesive cures.

Other variations not shown may be made. In variations of either the first or the second embodiment, the ring is formed of a material of sufficient elasticity that it can be formed without the slit and the inner diameter of the ring is temporarily deformed as it is pulled over the pipe end and into the gap 34. Various rubbery materials may be suitable for such embodiments, for instance silicones, thermoplastic elastomers and the like. In such cases an exit port may be provided with the same configuration as the entry port. In other variations one of the entry port or the slit may be omitted and replaced with a port at the top of the socket.

In still other embodiments, not shown the pipe end recess 34 may not extend into the flange ring and instead the flange ring inner wall is sized to frictionally engage the manufactured diameter of the pipe. In such cases the flange ring advantageously provides at least one or both of the entry and exit ports, but the assembly may have to be clamped during adhesive injection.

In other embodiments the socket may be modified to include an annular recess as shown U.S. Pat. No. 7,341,285, McPherson.

It should be understood that the invention has been described for the typical cylindrical pipe shape. The pipe may of course have a non-circular cross-section, in which case the respective socket and ring cross-sections should be complementary.

The adhesive is any adhesive suited for injection bonding the pipe materials. In preferred examples the adhesive is curable for instance based on polymerization or crosslinking of epoxy, acrylic, styrene and/or unsaturated polyester monomers or oligomers. The adhesive is suitably a substantially 100% solids adhesive that cures to a solid plastic. Two-part curable adhesives may be used such as epoxy adhesives, two-part urethanes and two-part acrylic adhesive that cure when the two parts are mixed. In specific examples the adhesive is a two-part curable acrylic adhesive such as described in Briggs US 20070155879; US 20070155899; U.S. Pat. No. 7,816,453; U.S. Pat. No. 7,795,351; U.S. Pat. No. 6,852,801; U.S. Pat. No. 6,602,958; U.S. Pat. No. 5,945,461; U.S. Pat. No. 5,206,288; ; U.S. Pat. No. 5,112,691; U.S. Pat. No. 4,959,405; U.S. Pat. No. 4,942,201; U.S. Pat. No. 4,773,957; U.S. Pat. No. 4,714,730; U.S. Pat. No. 4,536,546; U.S. Pat. No. 4,426,243; U.S. Pat. No. 4,183,644; U.S. Pat. No. 4,112,013; U.S. Pat. No. 4,106,971; U.S. Pat. No. 3,890,407; U.S. Pat. No. 4,200,400; U.S. Pat. No. 5,539,070; WO 98/32206; WO 01/44311; or U.S. Pat. No. 7,341,285. The adhesive may also be a one part adhesive such as a moisture curable urethane, a hot melt, an anaerobic curing acrylic or a cyanoacrylate adhesive.

Fillers and polymers may be utilized in the formulation to reduce shrinkage during cure, to provide suitable viscosity and thixotropy, and to provide desired cured properties such as high temperature stability, low temperature flexibility, cohesive strength and the like.

The injection ring is not limited for use with curable adhesives only. Solvent cements can also be used with the injection ring to fill the interstitial space.

The flange rings of the invention can be more effectively integrated into the bonded assembly than those of the prior art because they have larger adhesive contact areas and the adhesive forms a key way when cured that more effectively integrates the ring in the bonded assembly.

The pipe end and socket may be the same or different materials. In specific examples the pipe is a homopolymer or copolymer of one or more ethylenically unsaturated monomers, for instance olefin monomers, such as ethylene, propylene and butylene, vinyl monomers including vinyl chloride; of other ethylenically unsaturated monomers including acrylonitrile, acrylates, styrene, vinyl monomers, vinylidine fluoride, and the like. Particular examples include polyolefins such as polyethylene (PE), crosslinked polyethylene (PEX), polypropylene (PP), polybutylene; polyacetal; ABS, polyvinylchloride, chlorinated polyvinylchloride, polytetrafluoroethylene and the like. Composite pipe may be used for instance fiber reinforced thermoset polymers such as cured epoxy, acrylic, styrene and/or unsaturated polyester resins. Suitable reinforcing materials include carbon fibers, carbon nanotubes, glass fiber, mineral fibers, polymer fibers, such as polyaramid (Kevlar®) or polyolefin such as Spectra®, and the like.

The flange ring may be made of the same or different materials as the pipe and/or socket. The flange ring is suitably made of a plastic material, relatively rigid or resilient materials can be used. Various thermoplastic or crosslinked plastic materials can be used, provided the adhesive is one that provides good adhesion to each component of the joint.

In further aspects the invention also pertains to a pipe end design for an injection joint that includes an engagement portion which engages a top surface of a flange ring to prevent axial displacement of the ring during injection.

The above examples and disclosure are intended to be illustrative and not exhaustive. These examples and description will suggest many variations and alternatives to one of ordinary skill in this art. All these alternatives and variations are intended to be included within the scope of the claims, where the term “comprising” means “including, but not limited to”.

1. A flange ring for a pipe and socket injection joint, the flange ring comprising
a top surface,
a flange flat surface for engaging a top surface of a socket,
an outer ring wall extending in an upward direction from the flange flat surface,
a socket insertion portion extending in a downward direction spaced inwardly from the outer wall,
an injection port in the outer wall of the flange ring, and
a channel in the insertion portion which opens downward and is in fluid communication with the injection port.

2. A flange ring as in claim 1 wherein said channel is provided as a recess in an inner wall of the flange ring.

3. A flange ring as in claim 2 wherein said recess is annular.

4. A flange ring as in claim 3 wherein said insertion portion is tapered in the downward direction.

5. A flange ring as in claim 1 wherein said channel is provided as a slot extending downward through said insertion portion.

6. A flange ring as in claim 1 wherein the ring further comprises a slit that splits the ring at a location spaced circumferentially apart from said injection port.

7. A flange ring as in claim 6 wherein said slit is diametrically opposite the injection port.

8. An injection pipe joint assembly comprising:
a first pipe having a first pipe end,
a socket having a top and an interior cavity that receives the first pipe end with a gap therebetween, and
a flange ring as in claim 1 wherein said flange flat surface is in contact with the top of the top of the socket and the channel opens to the gap.

9. A flange ring for an injection joint of a pipe and socket joint, the flange ring comprising
a top surface,
a flange flat surface for engaging a top surface of a socket,
an outer ring wall extending in an upward direction from the flange flat surface,
a socket insertion portion extending in a downward direction spaced inwardly from the outer wall, and
a slit that splits the ring.

10. A flange ring as in claim 9 further comprising an injection port and a channel in the insertion portion which opens downward and is in fluid communication with the injection port.

11. An injection pipe joint assembly comprising:
a first pipe having a first pipe end,
a socket having a top and an interior cavity that receives the first pipe end with a gap therebetween, and
a flange ring as in claim 9 wherein said flange flat surface is in contact with the top of the top of the socket.

12. An injection pipe joint assembly as in claim 11 wherein the flange ring includes a slit that splits the ring and is in fluid communication with the gap.

13. An injection pipe joint assembly as in any one of claims 11 wherein
the first pipe end includes an outer wall, a bottom and a circumferential recess spaced upward of the bottom of the pipe end to define a stub extending from the bottom of the pipe end to the recess, and
said flange ring includes an inner wall received in the recess of the first pipe end and in frictional engagement therewith.

14. An injection pipe joint assembly as in claim 13 wherein the recess in the first pipe end includes a top edge that contacts the top of the flange ring and stops upward motion of the flange ring when adhesive is injected into the joint.

15. An injection pipe joint assembly as in claim 13 wherein at least a portion of the stub is in circumferential frictional engagement with the socket cavity.

16. An injection pipe joint assembly as in claim 11 wherein the flange ring insertion portion is tapered in the downward direction and the insertion portion is biased outwardly by inward deflection of the insertion portion during joint assembly.

17. An injection pipe joint assembly as in claim 16 where the socket includes a bevel at the top of the cavity and the flange ring insertion portion has been deflected inward by contact with the bevel during contact.

18. An injection pipe joint assembly as in claim 14 wherein the flange ring insertion portion includes an inner wall in contact with said recess, and an outer wall in contact with the socket, and the socket exerts inward pressure on the insertion portion sufficient to preclude leakage during adhesive injection.

19. An injection pipe joint assembly as in claim 18 wherein flange ring includes a slot in fluid communication with the injection port and the gap.

20. An injection pipe joint assembly as in claim 11 wherein the slit of the flange ring is spaced circumferentially apart from the injection port, and in fluid communication with the gap, and the slit functions as an exit port when adhesive is injected into the joint.

21. An injection pipe joint assembly as claim 11 further comprising a cured adhesive filling the gap.

22. An injection pipe joint assembly as in claim 20 further comprising a cured adhesive filling the injection port, channel, gap and exit port.

23. A method of forming an injection pipe joint comprising:
providing a pipe end with a bottom,
fitting a flange ring having an inner wall, outer wall onto the pipe end to form a pipe end/flange ring assembly, the flange ring including an injection port and a channel that opens downward in at least a portion of a insertion portion of the flange ring and that communicates with the injection port,
inserting pipe end/flange ring assembly into a socket to form an assembled pipe joint, the assembled pipe joint further comprising a gap between the pipe end and socket over a portion of the assembly inserted into the socket and an injection port, and the injection port communicating with the gap,
injecting a curable adhesive into the injection port in the flange ring to fill the gap.
